(19) United States
(12) Patent Application Publication
(10) Pub. No.: US 2015/0098044 A1
(43) Pub. Date: Apr. 9, 2015

(54) LIQUID CRYSTAL DISPLAY DEVICE

(71) Applicant: Japan Display Inc., Tokyo (JP)

(72) Inventor: Mitsuru WATANABE, Tokyo (JP)

(73) Assignee: Japan Display Inc.

(21) Appl. No.: 14/508,179

(22) Filed: Oct. 7, 2014

(30) Foreign Application Priority Data
Oct. 8, 2013 (JP) 2013-211292

(51) Int. Cl. G02F 1/1335

(52) U.S. Cl. CPC G02F 1/133603; G02F 1/133524
USPC 349/62

(57) ABSTRACT

There is provided a liquid crystal display device including a liquid crystal display panel and a backlight. The backlight includes a light guide plate with multiple LEDs arranged on a side surface, and a first optical sheet provided on the light guide plate. The first optical sheet has an upper surface, a lower surface, and a side surface on the side of the LEDs. A light shielding area is formed in the side surface of the first optical sheet. By forming the light shielding area, the light from the LED can be prevented from entering the first optical sheet from the side surface. As a result, it is possible to prevent the uneven brightness due to the first optical sheet from occurring in the end portion of the screen.

### CLAIM OF PRIORITY

The present application claims priority from Japanese Patent Application JP 2013-211292 filed on Oct. 8, 2013, the content of which is hereby incorporated by reference into this application.

### BACKGROUND

The present invention relates to a liquid crystal display device, in particular, a liquid crystal display device including a backlight with an LED as the light source, which is designed to address the problem of uneven brightness in the vicinity of the light source.

A liquid crystal display device includes a TFT substrate in which pixel electrodes, thin film transistors (TFTs) and the like are formed in a matrix, as well as a counter substrate in which color filters and the like are formed at positions corresponding to the pixel electrodes of the TFT substrate. The counter substrate is disposed opposite the TFT substrate with a liquid crystal interposed between the TFT substrate and the counter substrate. Then, an image is formed by controlling each pixel transmittance of light by the liquid crystal molecules.

The liquid crystal display device, which can be made thin and light, is widely used in small display devices such as mobile phones. The liquid crystal does not emit light by itself, so that a backlight is provided on the back side of the liquid crystal display panel. In the liquid crystal display device such as a mobile phone, a light emitting diode (LED) is used as a light source of the backlight. The backlight has a structure formed by arranging LEDs on a side surface of a light guide plate, providing various optical sheets on the light guide plate, and placing these optical components in a mold. The method of arranging LEDs on a side surface of the light guide plate is called the side lighting method.

In a liquid crystal display device including a light source using the side lighting method, there is a case where a portion of the light from the light source provided on a side surface of the light guide plate does not enter the light guide plate but enters the liquid crystal display panel directly from a side surface of the liquid crystal display panel. Such light can cause not only uneven brightness but also contrast degradation. Japanese Patent Application Laid-Open No. 2004-20814 describes a structure capable of preventing the light from the backlight from directly entering the periphery of the liquid crystal display panel, by providing a light shielding sheet including a light transmitting part and a light shielding part on the light guide plate so that the light shielding part of the light shielding sheet covers over the light source. Further, Japanese Patent Application Laid-Open No. 2004-20814 also describes a structure capable of preventing the light from the light source from directly entering the liquid crystal display panel, by providing a light shielding material on the side surface of the liquid crystal display panel.

Japanese Patent Application Laid-Open No. 2008-203875 describes a structure capable of preventing uneven brightness in the periphery of the display area, by forming a black matrix in an end portion of a counter substrate, forming a light shielding area of a metal on an end surface of a TFT substrate, and providing a light shielding material on the outside of the sealing material for bonding the TFT substrate and the counter substrate together.

### SUMMARY

In recent years, an LED is also used as the light source in medium-size liquid crystal display panels using the side-lighting method, in order to respond to the demand for size reduction and the like. Since an LED is a so-called point light source, it is necessary to provide multiple LEDs on a side of the light guide plate. FIG. 11 is a plan view of a backlight in this state. FIG. 12 is a cross-sectional view of the backlight in a portion including an LED. In FIG. 12, an optical sheet group 60 is provided on a light guide plate 10. The optical sheet group 60 includes a diffusion sheet, a prism sheet, and the like, which will be described below.

In FIG. 11, multiple LEDs 100 are arranged on a side surface of the light guide plate 10. Since the LED 100 is a point light source, as shown in FIG. 11, the brightness of the surface facing the LED 100 is increased and the brightness between the individual LEDs 100 is reduced. As a result, a bright part is periodically generated at positions corresponding to the LEDs 100, causing image quality degradation particularly in the periphery of the screen.

Such uneven brightness due to the arrangement of the LEDs 100 is more significant as the distance DL between the LEDs 100 and the light guide plate 10 becomes smaller and the pitch PL between the LEDs 100 becomes larger in FIG. 11. However, if the distance DL between the LEDs 100 and the light guide plate 10 is increased, the light use efficiency is reduced and, at the same time, the size of the entire liquid crystal display device is increased. Further, if the pitch PL between the LEDs 100 is reduced, the number of LEDs 100 is increased. As a result, the production cost is increased.

Such problems have been addressed by the structure of the light guide plate. However, the existing solution with the light guide panel is not enough for liquid crystal display devices, particularly, those for medical use or other devices requiring increased light intensity of the backlight. More specifically, it has been found that such uneven brightness does not occur only by the light directly entering the side surface of the light guide plate 10 from the LED 100. In other words, it has been found that, as shown in FIG. 12, not only the light from the LED 100 is incident on the side surface of the light guide plate 10 as indicated by the arrow A, but also a portion of the light from the LED 100 goes to the side surface of the optical sheet group 60 as indicated by the arrow B. As a result, the light incident on the side surface of the optical sheet group 60 goes to the liquid crystal display panel to increase the uneven brightness in the periphery of the screen.

In FIG. 12, a reflective sheet 70 is provided below the light guide plate 10 to direct the light going to the underside of the light guide plate 10, towards the side of the liquid crystal display panel to increase the light use efficiency. A lower diffusion sheet 20, a lower prism sheet 30, an upper prism sheet 40, and an upper diffusion sheet 50 are provided in this order on the light guide plate 10.

FIG. 13 is an example of the optical sheet group 60 provided on the light guide plate 10. In FIG. 13, the bottom side is the lower diffusion sheet 20. The role of the lower diffusion sheet 20 is to diffuse the light emitted from the light guide plate 10 to achieve uniform light emission. The lower prism sheet 30 is provided on the lower diffusion sheet 20. The lower prism sheet 30 is, for example, as shown in FIG. 13, a sheet in which prisms having a triangular cross section extend in the horizontal direction and are arranged in the vertical direction. The pitch of each prism is approximately 50 μm. In FIG. 13, the lower prism sheet 30 has the role to direct the light spread in the a direction, towards the direction perpendicular to the lower prism sheet 30 to increase the light use efficiency.

The upper prism sheet 40 is provided on the lower prism sheet 30. The upper prism sheet 40 is, for example, as shown in FIG. 13, a sheet in which prisms having a triangular cross section extend in the vertical direction and are arranged in the horizontal direction. The pitch of each prism is approximately 50 μm. FIG. 13, the upper prism sheet 40 has the role to direct the light spread in the b direction, towards the direction perpendicular to the upper prism sheet 40 to increase the light use efficiency.

In FIG. 13, the upper diffusion sheet 50 is provided on the upper prism sheet 40. The role of the upper diffusion sheet 50 is to prevent moiré from appearing due to the interference between scanning lines and video signal lines formed on the TFT substrate, and the lower prism sheet 30 as well as the upper prism sheet 40. Note that if there is another method for preventing moiré and when it is desired to increase the screen brightness, a reflection type polarizing film is used instead of the upper diffusion sheet 50. The reflection type polarizing film only reflects light not transmitting the lower polarizing plate, and reflects the light again by a reflective sheet provided on the bottom of the backlight. At the same time, the phase of the light is changed to allow the light to pass through the reflection type polarizing film, in order to increase the light use efficiency. Note that both the upper prism sheet and the reflection type polarizing film can be used at the same time.

As shown in FIG. 11, the relationship between the light guide plate 10 and the optical sheet group 60, which are of interest in the present invention, is such that at least on the LED side, the end surfaces of the light guide plate 10 and the optical sheet group 60 are substantially the same, or the optical sheet group 60 is formed slightly inside the light guide plate 10. In other words, the optical sheet group 60 according to the present invention is not designed to cover over the upper surface of the light source, like the light shielding sheet described in Japanese Patent Application Laid-Open No. 2004-20814.

Each optical sheet has a thickness and includes an upper surface on the side of the liquid crystal display panel, a lower surface on the side of the light guide plate, and a side surface in the thickness direction. In this structure, the light from the LED enters from the side surface of the optical sheet, causing uneven brightness in the optical sheet, which is a phenomenon in which the brightness at a position corresponding to the LED increases and the brightness at a position between the LEDs decreases.

An object of the present invention is to prevent uneven brightness from occurring at a position corresponding to the LED in the periphery of the screen due to the light from the LED directly entering the optical sheet group.

The present invention is made to overcome the above problems. Specific solutions are as follows.

(1) There is provided a liquid crystal display device including a liquid crystal display panel and a backlight. The backlight includes a light guide plate with multiple LEDs arranged on a side surface, and a first optical sheet provided on the light guide plate. The first optical sheet is not designed to cover the multiple LEDs entirely. The first optical sheet has an upper surface, a lower surface, and a side surface on the side of the LEDs. Then, a light shielding area is formed in the side surface of the first optical sheet.

(2) There is provided a liquid crystal display device including a liquid crystal display panel and a backlight. The backlight includes a light guide plate with multiple LEDs arranged on a side surface, and a first optical sheet provided on the light guide plate. The first optical sheet is not designed to cover the multiple LEDs entirely. The first optical sheet has an upper surface, a lower surface, and a side surface on the side of the LEDs. A light shielding area is formed in the side surface of the first optical sheet at a position corresponding to the LED. The light shielding area is not formed in the side surface of the first optical sheet at a position corresponding to the space between the LEDs.

(3) There is provided a liquid crystal display device including a liquid crystal display panel and a backlight. The backlight includes a light guide plate with multiple LEDs arranged on a side surface, and a first optical sheet provided on the light guide plate. The first optical sheet is not designed to cover the multiple LEDs entirely. The first optical sheet has an upper surface, a lower surface, and a side surface on the side of the LEDs. A sawtooth unevenness, as seen in a plan view, is formed in the side surface of the first optical sheet.

(4) In the liquid crystal display device described in (3), the pitch of the sawtooth unevenness at a position corresponding to the LED is smaller than the pitch of the sawtooth unevenness at a position corresponding to the space between the LEDs.

(5) In the liquid crystal display device described in (3), the height of the sawtooth unevenness at a position corresponding to the LED is smaller than the height of the sawtooth unevenness at a position corresponding to the space between the LEDs.

(6) There is provided a liquid crystal display device including a liquid crystal display panel and a backlight. The backlight includes a light guide plate with multiple LEDs arranged on a side surface, and a first optical sheet provided on the light guide plate. The first optical sheet is not designed to cover the multiple LEDs entirely. The first optical sheet has an upper surface, a lower surface, and a side surface on the side of the LEDs. A wavy unevenness, as seen in a plan view, is formed in the side surface of the first optical sheet.

(7) In the liquid crystal display device described in (6), the pitch of the wavy unevenness at a position corresponding to the LED is smaller than the pitch of the wavy unevenness at a position corresponding to the space between the LEDs.

(8) In the liquid crystal display device described in (6), the height of the wavy unevenness at a position corresponding to the LED is smaller than the height of the wavy unevenness at a position corresponding to the space between the LEDs.

(9) In the liquid crystal display device described in (6), the wavy unevenness has a concave shape at a position corresponding to the LED, and has a convex shape at a position corresponding to the space between the LEDs.

(10) A liquid crystal display device including a liquid crystal display panel and a backlight. The backlight includes a light guide plate with multiple LEDs arranged on a side surface, and a first optical sheet provided on the light guide plate. The first optical sheet is not designed to cover the multiple LEDs entirely. The first optical sheet has an upper surface, a lower surface, and a side surface on the side of the LEDs. The side surface is inclined at an angle less than 90 degrees with respect to the lower surface.

According to the present invention, the light from the LED can be prevented from directly entering the optical sheet group. Thus, it is possible to prevent uneven brightness from occurring at positions corresponding to the individual LEDs in the periphery of the screen, corresponding to the optical sheet group. Further, according to another aspect of the present invention, the end surface of the optical sheet has a structure in which light shielding means is provided in the optical sheet at a position corresponding to the LED so that the light is allowed to pass through between the LEDs. In this way, the optical sheet can offset the uneven brightness at positions corresponding to the individual LEDs, even if the uniformity of the uneven brightness due to the LED arrangement by the light guide plate is insufficient. Thus, the uneven brightness in the periphery of the screen can be prevented more efficiently.

### BRIEF DESCRIPTION OF THE DRAWINGS

FIG. 1 is a perspective view of a lower diffusion sheet in a first embodiment;

FIG. 2 is a perspective view of another form of the lower diffusion sheet in the first embodiment;

FIG. 3 is a perspective view of still another form of the lower diffusion sheet in the first embodiment;

FIG. 4 is a perspective view showing the positional relationship between a lower diffusion sheet and LEDs in a second embodiment;

FIG. 5 is a plan view of a lower diffusion sheet in a third embodiment;

FIG. 6 is a plan view of another form of the lower diffusion sheet in the third embodiment;

FIG. 7 is a plan view of a lower diffusion sheet in a fourth embodiment;

FIG. 8 is a plan view of another form of the lower diffusion sheet in the fourth embodiment;

FIG. 9 is a plan view of a lower diffusion sheet in a fifth embodiment;

FIGS. 10A and 10B are perspective views of a lower diffusion sheet in a sixth embodiment;

FIG. 11 is a plan view showing a problem of the backlight in the related art;

FIG. 12 is a cross-sectional view showing the problem of the backlight in the related art; and

FIG. 13 is a perspective view of an example of an optical sheet group.

### DETAILED DESCRIPTION

Hereinafter, the details of the present invention will be described with reference to the preferred embodiments.

### First Embodiment

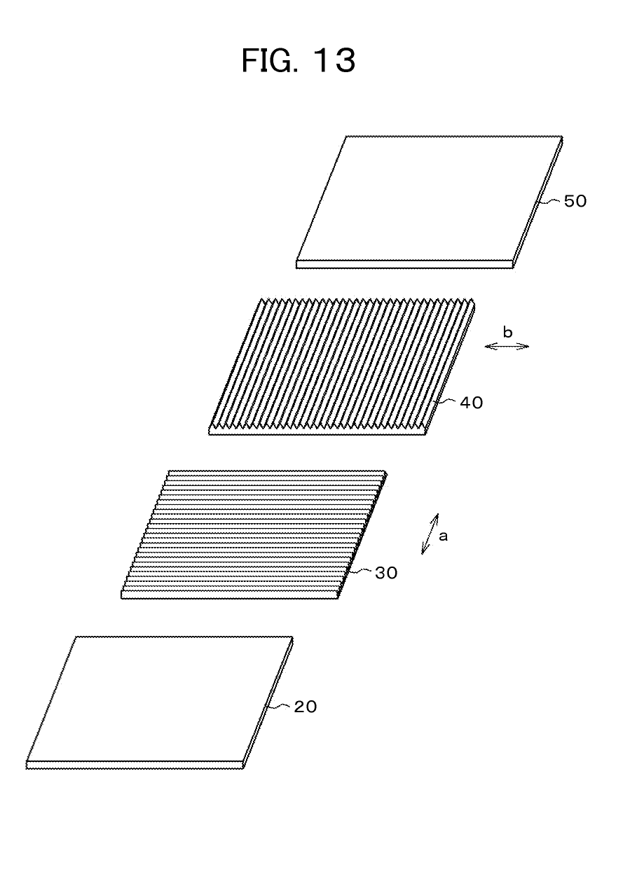

As described with reference to FIG. 13, the optical sheet group includes the lower diffusion sheet 20, the upper diffusion sheet 50, the lower prism sheet 30, the upper prism sheet 40, the refection type polarizing film, and the like. The present invention will now be described with an example of the lower diffusion sheet 20. However, the present invention is also applicable to other optical sheets. Note that the lower diffusion sheet 20 is the closest to the LEDs which are the light source, in which the effect of the present invention is most likely to be seen.

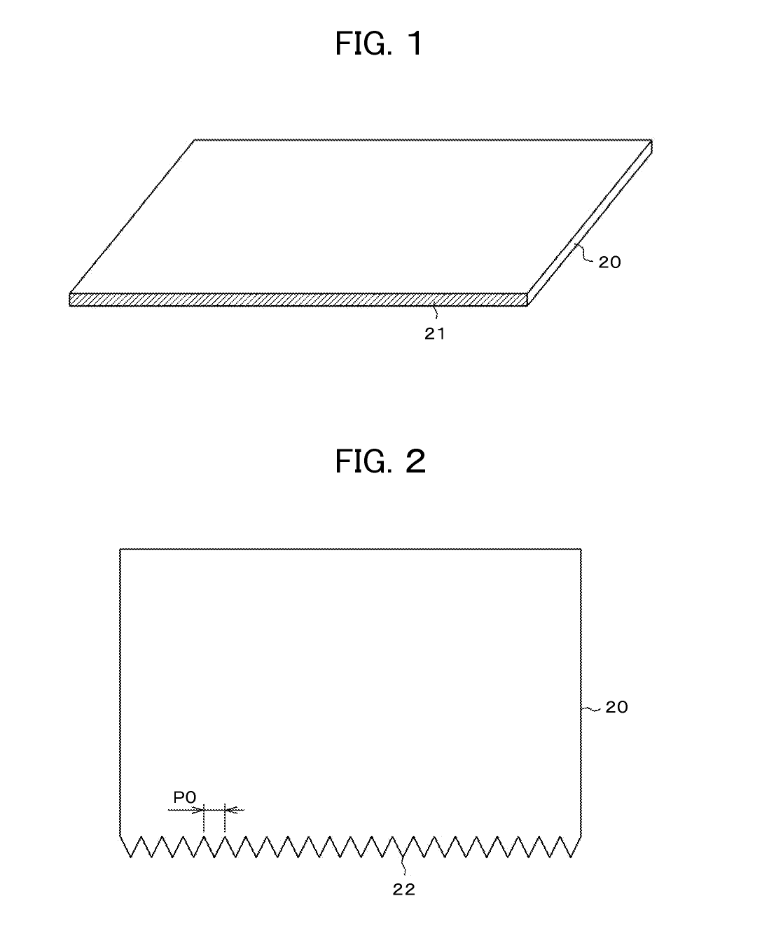

FIG. 1 is a perspective view of the lower diffusion sheet 20 associated with the present invention. In FIG. 1, a light shielding area 21 is formed over a side surface of the lower diffusion sheet 20 on the side of the LEDs which are the light source. The light shielding area 21 shown in FIG. 1 is an example in which a light shielding paint is applied on the side surface of the lower diffusion sheet 20. Here, for example, an oil-based black ink and the like can be used for the light shielding paint. The light shielding paint can be applied on each lower diffusion sheet 20, or applied on multiple lower diffusion sheets 20 simultaneously by printing or other suitable means.

By forming the light shielding area 21, the light from the LED 100 can be prevented from entering from the side surface of the lower diffusion sheet 20. Thus, it is possible to eliminate the uneven brightness in the end portion of the screen due to the lower diffusion sheet 20, which is associated with the positions of the LEDs 100. The uneven brightness in the end portion of the screen due to the positions of the LEDs 100 looks like eyeballs and is also called eyeball irregularity. In the following description, the uneven brightness in the end portion of the screen due to the positions of the LEDs 100 may also be referred to as the eyeball irregularity.

The light shielding of the side surface of the lower diffusion sheet 20 shown in FIG. 1 can also be achieved by applying a frost treatment to the side surface. The frost treatment can be carried out using techniques such as sandblast for roughening the surface by chemical polishing and applying fine particles on the surface by spraying. In this case, it is effective when multiple lower diffusion sheets 20 are processed at the same time.

FIG. 2 is a plan view of the lower diffusion sheet 20, showing another aspect of the present embodiment in which a side surface of the lower diffusion sheet 20 on the side of the LEDs 100 as the light source is formed into a sawtooth unevenness 22. By forming the side surface of the lower diffusion sheet 20 into the sawtooth unevenness 22, it is possible to increase the amount of light from the LEDs 100 that is totally reflected on the side surface, and to reduce the uneven brightness in the end portion of the screen due to the positions of the LEDs 100 associated with the lower diffusion sheet 20.

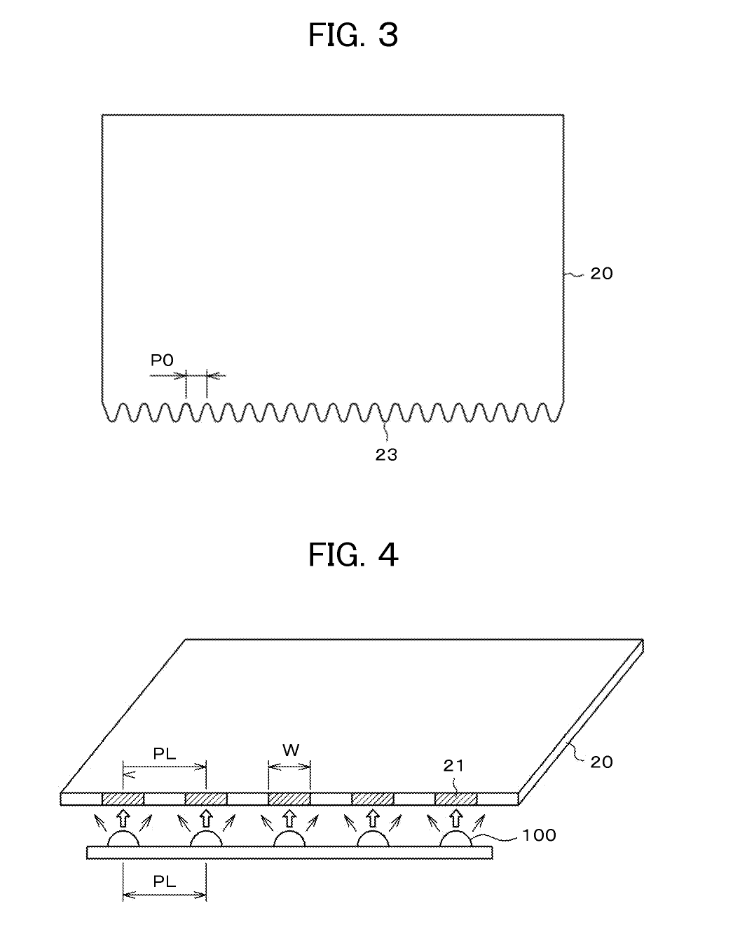

FIG. 3 is a plan view of the lower diffusion sheet 20, showing still another aspect of the present embodiment. In FIG. 3, the side surface facing the LEDs 100 is formed into a wavy unevenness 23. The effect is the same as that described in FIG. 2. In other words, in FIG. 3, the effect is to reduce the uneven brightness in the end portion of the screen due to the positions of the LEDs 100 associated with the lower diffusion sheet 20 by forming the surface facing the LEDs 100 into the wavy unevenness.

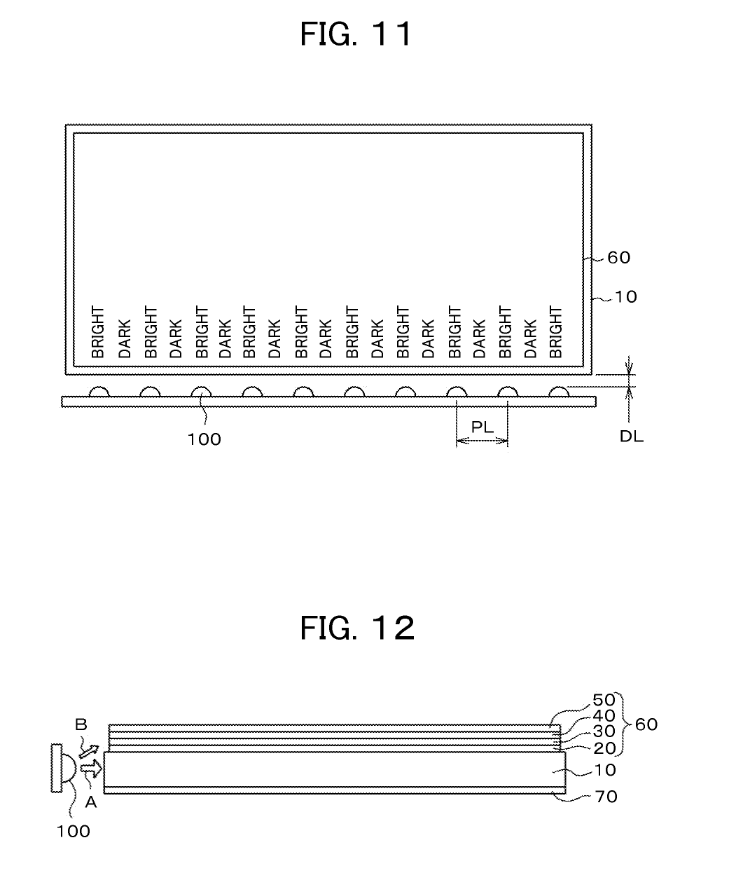

The lower diffusion sheet 20 shown in FIG. 2 or 3 is formed by punching out with a press. At this time, the required surface can be formed into the sawtooth unevenness 22 or the wavy unevenness 23 by punching out, without increasing the number of production steps. The pitch P0 of the sawtooth unevenness 22 shown in FIG. 2, or the pitch P0 of the wavy unevenness 23 shown in FIG. 3 is smaller than the pitch PL of the LED shown in FIG. 11.

As described above, the feature of the present embodiment is to reduce the uneven brightness in the end portion of the screen due to the positions of the LEDs 100, by shielding or significantly reducing the light entering the lower diffusion sheet 20 from the LEDs 100.

### Second Embodiment

FIG. 4 is a perspective view showing the relationship between the lower diffusion sheet 20 and the LEDs 100, which is the feature of a second embodiment. As shown in FIG. 4, a light shielding area 21 is formed on a surface of the lower diffusion sheet 20 facing the LEDs 100 with the same pitch as the pitch PL of the arrangement of the LEDs 100. In other words, the light shielding areas 21 are formed on the surface facing the LEDs 100, and the light shielding area is not formed between the LEDs.

With the structure shown in FIG. 4, the light from the LEDs 100 indicated by the white arrow does not enter the lower diffusion sheet 20 from the surface of the lower diffusion sheet 20 on the side facing the LEDs 100, while the light from the LEDs 100 indicated by the black arrow enters the lower diffusion sheet 20 by passing between the LEDs 100. In the light guide plate 10 provided below the lower diffusion sheet 20, the brightness of the surface facing each LED 100 is large, and the brightness between the LEDs 100 is small. In order to solve this problem, in the lower diffusion sheet 20, the brightness of the surface facing each LED 100 is reduced and the brightness between the LEDs 100 is increased. In this way, the uneven brightness due to the positions of the LEDs 100 in the light guide plate 10 can be compensated by the lower diffusion sheet 20. As a result, it is possible to reduce the uneven brightness due to the positions of the LEDs 100.

In FIG. 4, the width W of the light shielding area 21 is half the pitch PL of the light shielding area, but the present invention is not limited to this example. The width W can be set so that the uneven brightness is reduced most. Preferably, the width W of the light shielding area 21 is half or more of the pitch PL of the light shielding area 21 in terms of a reduction in the absolute intensity of the light from the LED 100 to the lower diffusion sheet 20.

### Third Embodiment

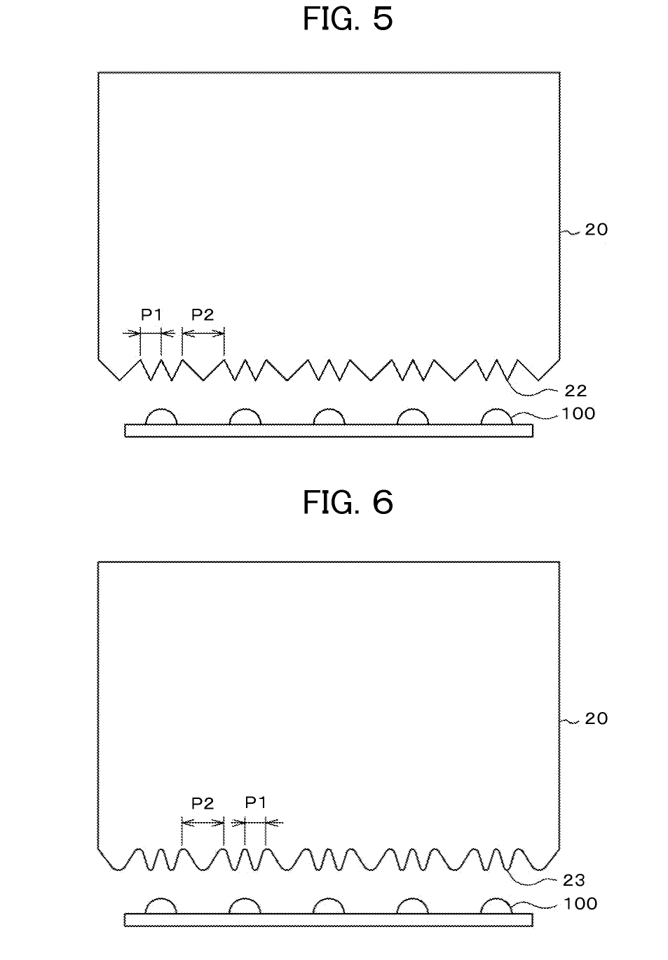

FIG. 5 is a plan view showing the relationship between the lower diffusion sheet 20 and the LEDs 100 according to a third embodiment. In FIG. 5, the sawtooth unevenness 22 is formed in a side surface of the lower diffusion sheet 20 facing the LEDs 100. The feature of FIG. 5 is in that the pitch P1 of the sawtooth unevenness 22 in the surface of the lower diffusion sheet 20 on the side facing the LEDs 100 is smaller than the pitch P2 of the sawtooth unevenness between the LEDs 100.

By reducing the pitch P1 of the sawtooth unevenness 22 in the area facing the LED 100, it is possible to increase the amount of total reflection of light with respect to the light entering the lower diffusion sheet 20 from the LEDs 100. In this way, it is possible to reduce the light entering from the surface facing the LED 100. On the other hand, in the lower diffusion sheet 20, the pitch of the sawtooth unevenness 22 is increased between the LEDs 100 to allow the light from the LEDs 100 to easily enter the lower diffusion sheet 20.

With the structure described above, in the lower diffusion sheet 20, it is possible to reduce the brightness in the area facing the LED 100 and to increase the brightness between the LEDs 100. As a result, the uneven brightness due to the positions of the LEDs 100 in the light guide plate 10 can be compensated by the brightness distribution in the lower diffusion sheet 20. Thus, the uneven brightness in the end portion of the screen due to the positions of the LEDs 100 can be reduced as a whole.

FIG. 6 is a plan view of another aspect of the present embodiment. FIG. 6 is different from FIG. 5 in that the side of the lower diffusion sheet 20 facing the LEDs 100 is formed into the wavy unevenness 23. The pitch P1 of the wave in the area facing the LED 100 is smaller than the pitch P2 of the wave in the area between the LEDs 100. The effect is the same as that described in FIG. 5. In other words, In FIG. 6, the effect is to increase the amount of total reflection of light in the area facing the LED 100, and to allow the light from the LEDs 100 to easily enter between the LEDs 100.

In this way, the uneven brightness due to the positions of the LEDs 100 in the light guide plate 10 can be compensated by the brightness distribution in the lower diffusion sheet 20. Thus, similarly to FIG. 5, the uneven brightness in the end portion of the screen due to the positions of the LEDs 100 can be reduced as a whole. FIG. 6 has a feature in that the side of the end surface facing the LEDs has the wavy unevenness 23, instead of the sawtooth unevenness 22, and is not easily deformed.

The lower diffusion sheet 20 according to the present embodiment can also be formed by punching out with a press or other suitable means. It is possible to further increase the life of the die for punching in FIG. 6, in terms of the curved surface as compared to the case of FIG. 5.

### Fourth Embodiment

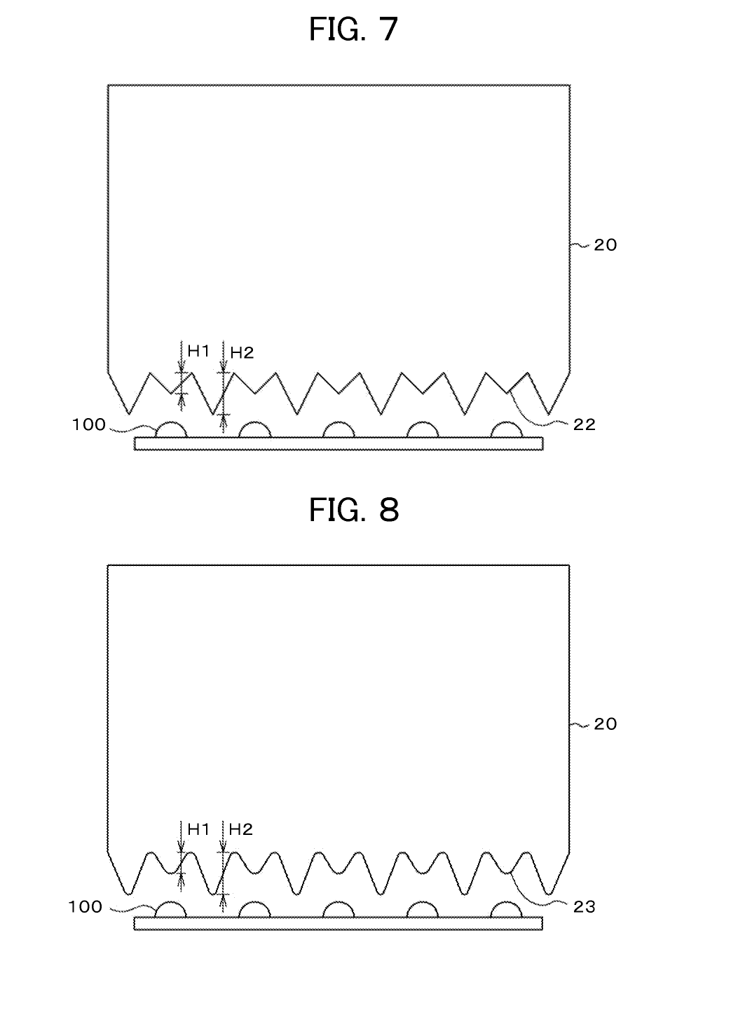

FIG. 7 is a plan view showing the relationship between the lower diffusion sheet 20 and the LEDs 100 according to a fourth embodiment. In FIG. 7, the side of the lower diffusion sheet 20 facing the LEDs 100 is formed into the sawtooth unevenness 22. The feature of FIG. 7 is in that the pitch of the sawtooth unevenness 22 on the surface of the lower diffusion sheet 20 on the side facing the LEDs 100 is fixed, but the height H1 of the sawtooth unevenness 22 in the area facing the LED is smaller than the height H2 of the sawtooth unevenness 22 between the LEDs 100.

With the structure described above, it is possible to increase the amount of total reflection of light from the LED 100 in the area of the lower diffusion sheet 20 facing the LED 100, to prevent the light from entering the lower diffusion sheet 20. On the other hand, it is designed to allow the light from the LED 100 to easily enter the lower diffusion sheet 20 between the LEDs 100. In this way, it is possible to prevent the light from entering the lower diffusion sheet 20 in the area facing the LED 100, and to increase the light entering the lower diffusion sheet 20 in the area between the LEDs 100. As a result, the uneven brightness due to the positions of the LEDs 100 in the light guide plate 10 can be compensated by the brightness distribution in the lower diffusion sheet 20. Thus, the uneven brightness in the end portion of the screen due to the positions of the LEDs 100 can be reduced as a whole.

FIG. 8 is a plan view of another aspect of the present embodiment. FIG. 8 is different from FIG. 7 in that the side of the lower diffusion sheet 20 facing the LEDs 100 is formed into the wavy unevenness 23. The pitch of the wave is fixed. However, the height H1 of the wave in the area facing the LED 100 is smaller than the height H2 of the wave between the LEDs. The effect is the same as that described in FIG. 7. In other words, in FIG. 8, the effect is to increase the amount of total reflection of light in the area facing the LED 100, and to allow the light from the LEDs 100 to easily enter between the LEDs 100.

In this way, the uneven brightness due to the positions of the LEDs 100 in the light guide plate 10 can be compensated by the brightness distribution in the lower diffusion sheet 20. Thus, similarly to FIG. 7, the uneven brightness in the end portion of the screen due to the positions of the LEDs 100 can be reduced as a whole. FIG. 8 has a feature in that the side of the end surface facing the LEDs has the wavy unevenness 23, instead of the sawtooth unevenness 22, and is not easily deformed

Also the lower diffusion sheet 20 according to the present embodiment can be formed by punching out with a press or other suitable means. It is possible to further increase the life of the die for punching in FIG. 8, in terms of the curved surface, as compared to the case of FIG. 7.

### Fifth Embodiment

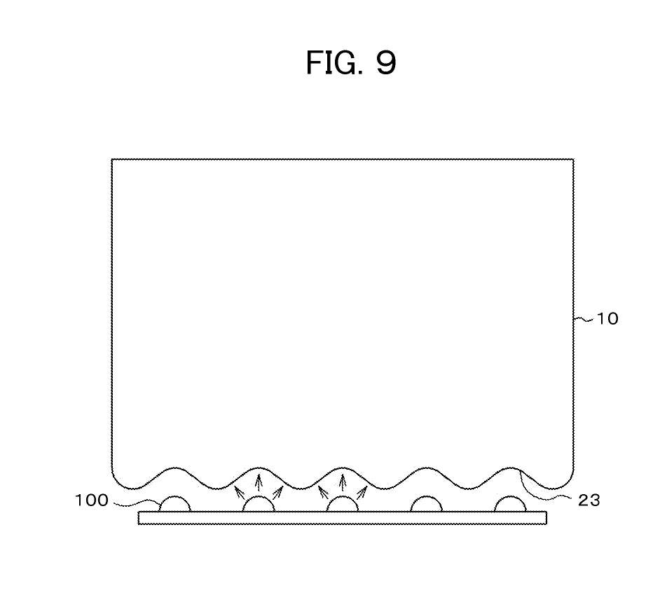

FIG. 9 is a plan view showing the relationship between the lower diffusion sheet 20 and the LEDs 100 according to a fifth embodiment. In FIG. 9, a concave shape is formed in the lower diffusion sheet 20 at a position facing the LED 100. As a result, in the lower diffusion sheet 20, a concave lens is formed at a position corresponding to the LED 100, and a convex lens is formed at a position between the LEDs 100.

In other words, the concave lens at a position facing the LED 100 has the effect of diffusing the light entering the lower diffusion sheet 20 to right and left, and the convex lens at a position between the LEDs 100 has the effect of focusing the light entering the lower diffusion sheet 20. With this structure, it is possible to reduce the amount of light entering the lower diffusion sheet 20 at a position facing the LED 100, and to increase the amount of light entering the lower diffusion sheet 20 at a position between the LEDs 100. Thus, the amount of light entering the lower diffusion sheet 20 can be more uniform. As a result, it is possible to reduce the uneven brightness due to the positions of the LEDs 100 in the end portion of the screen.

### Sixth Embodiment

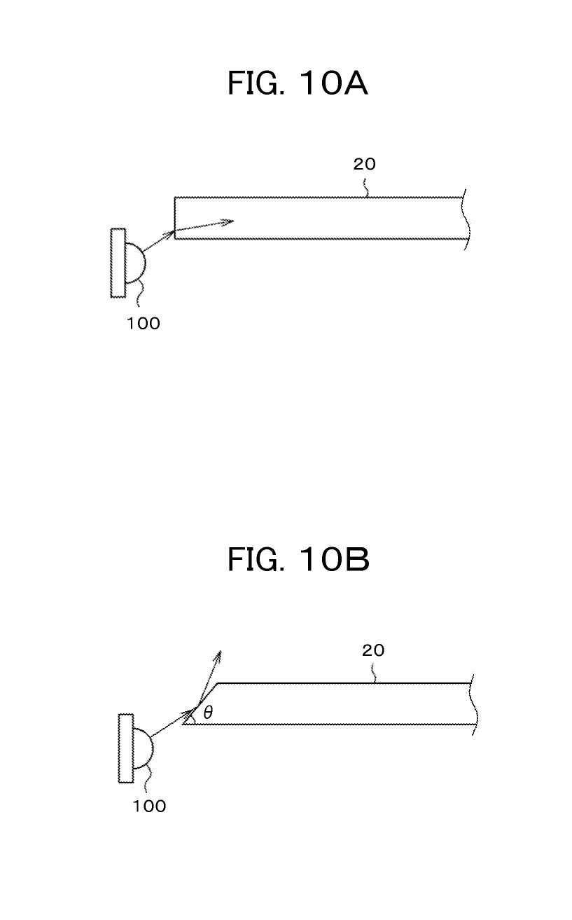

FIGS. 10A and 10B are schematic views showing the present embodiment, in which FIG. 10A is a conventional example and FIG. 10B is the present embodiment. In the conventional example shown in FIG. 10A, the light entering the side surface of the lower diffusion sheet 20 from the LED 100 is refracted and enters the lower diffusion sheet 20. On the other hand, in the present embodiment, as shown in FIG. 10B, the side surface of the lower diffusion sheet 20 on the side of the LED 100 is inclined at an angle θ with respect to the bottom surface. The angle θ is less than 90 degrees. Preferably θ is set to 70 degrees or less, in order to further increase the effect of the present embodiment.

Since the side surface of the lower diffusion sheet 20 is inclined, as shown in FIG. 10B, the light from the LED 100 is totally reflected at the side surface. Thus, the light from the LED 100 does not enter the lower diffusion sheet 20. With this structure, the uneven brightness due to the positions of the LEDs 100 is prevented from occurring in the lower diffusion sheet 20. In this way, it is possible to suppress the uneven brightness due to the positions of the LEDs 100 associated with the lower diffusion sheet 20.

The foregoing embodiments have been described with respect to the lower diffusion sheet 20. However, the same effect can also be obtained with respect to other optical sheets, for example, such as the lower prism sheet 30, the upper prism sheet 40, the upper diffusion sheet 50, and the reflection type polarizing film, by using the same structures.

What is claimed is:

1. A liquid crystal display device comprising a liquid crystal display panel and a backlight,
wherein the backlight includes a light guide plate with a plurality of LEDs arranged on a side surface, and a first optical sheet provided on the light guide plate,
wherein the first optical sheet is not designed to cover the LEDs entirely,
wherein the first optical sheet has an upper surface, a lower surface, and a side surface on the side of the LEDs, and
wherein a light shielding area is formed in the side surface of the first optical sheet.

2. The liquid crystal display device according to claim 1, wherein the light shielding area is formed by applying ink.

3. The liquid crystal display device according to claim 1, wherein the light shielding area is formed by applying a frost treatment.

4. A liquid crystal display device comprising a liquid crystal display panel and a backlight,
wherein the backlight includes a light guide plate with a plurality of LEDs arranged on a side surface, and a first optical sheet provided on the light guide plate,
wherein the first optical sheet is not designed to cover the LEDs entirely,
wherein the first optical sheet has an upper surface, a lower surface, and a side surface on the side of the LEDs, and
wherein a light shielding area is formed in the side surface of the first optical sheet at a position corresponding to the LED, and the light shielding area is not formed in the side surface of the first optical sheet at a position corresponding to the space between the LEDs.

5. A liquid crystal display device comprising a liquid crystal display panel and a backlight,
wherein the backlight includes a light guide plate with a plurality of LEDs arranged on a side surface, and a first optical sheet provided on the light guide plate,
wherein the first optical sheet is not designed to cover the LEDs entirely,
wherein the first optical sheet has an upper surface, a lower surface, and a side surface on the side of the LEDs, and
wherein a sawtooth unevenness, as seen in a plan view, is formed on the side surface of the first optical sheet.

6. The liquid crystal display device according to claim 5, wherein the pitch of the sawtooth unevenness at a position corresponding to the LED is smaller than the pitch of the sawtooth unevenness at a position corresponding to the space between the LEDs.

7. The liquid crystal display device according to claim 5, wherein the height of the sawtooth unevenness at a position corresponding to the LED is smaller than the height of the sawtooth unevenness at a position corresponding to the space between the LEDs.

8. A liquid crystal display device comprising a liquid crystal display panel and a backlight,
wherein the backlight includes a light guide plate with a plurality of LEDs arranged on a side surface, and a first optical sheet provided on the light guide plate,
wherein the first optical sheet is not designed to cover the LEDs entirely,
wherein the first optical sheet has an upper surface, a lower surface, and a side surface on the side of the LEDs, and
wherein a wavy unevenness, as seen in a plan view, is formed in the side surface of the first optical sheet.

9. The liquid crystal display device according to claim 8, wherein the pitch of the wavy unevenness at a position corresponding to the LED is smaller than the pitch of the wavy unevenness at a position corresponding to the space between the LEDs.

10. The liquid crystal display device according to claim 8, wherein the height of the wavy unevenness at a position corresponding to the LED is smaller than the height of the wavy unevenness at a position corresponding to the space between the LEDs.

11. The liquid crystal display device according to claim 8, wherein the wavy unevenness has a concave shape at a position corresponding to the LED, and has a convex shape at a position corresponding to the space between the LEDs.

12. A liquid crystal display device comprising a liquid crystal display panel and a backlight,
wherein the backlight includes a light guide plate with a plurality of LEDs arranged on a side surface, and a first optical sheet provided on the light guide plate,
wherein the first optical sheet is not designed to cover the LEDs entirely,
wherein the first optical sheet has an upper surface, a lower surface, and a side surface on the side of the LEDs, and
wherein the side surface is inclined at an angle less than 90 degrees with respect to the bottom surface.

13. The liquid crystal display device according to claim 12, wherein the angle of the inclined surface is 70 degrees or less.

14. The liquid crystal display device according to claim 1,
wherein the backlight includes another optical sheet on the first optical sheet, and
wherein the other optical sheet has the structure descried in claim 1.

15. The liquid crystal display device according to claim 4,
wherein the backlight includes another optical sheet on the first optical sheet, and
wherein the other optical sheet has the structure described in claim 4.

16. The liquid crystal display device according to claim 5,
wherein the backlight includes another optical sheet on the first optical sheet, and
wherein the other optical sheet has the structure described in claim 5.

17. The liquid crystal display device according to claim 8,
wherein the backlight includes another optical sheet on the first optical sheet, and
wherein the other optical sheet has the structure described in claim 8.

18. The liquid crystal display device according to claim 12,
wherein the backlight includes another optical sheet on the first optical sheet, and
wherein the other optical sheet has the structure described in claim 12.
